(19) United States
(12) Patent Application Publication
(10) Pub. No.: US 2024/0272604 A1
(43) Pub. Date: Aug. 15, 2024

(54) EVALUATION PROGRAM CREATION DEVICE AND COMPUTER-READABLE RECORDING MEDIUM RECORDING PROGRAM

(71) Applicant: FANUC CORPORATION, Yamanashi (JP)

(72) Inventors: Shunsuke AOKI, Yamanashi (JP); Nobuaki AIZAWA, Yamanashi (JP)

(21) Appl. No.: 18/681,068

(22) PCT Filed: Aug. 27, 2021
(86) PCT No.: PCT/JP2021/031571

§ 371 Date: Feb. 5, 2024

(51) Int. Cl. G05B 19/402

(52) U.S. Cl. CPC G05B 19/402; G05B 2219/50047

(57) ABSTRACT

An evaluation program creation device according to the present disclosure comprises a parameter acquisition unit that acquires a parameter relating to machining by an industrial machine, a shape selection unit that selects a machining shape necessary for evaluating the parameter on the basis of the acquired parameter, a dimension calculation unit that calculates the dimension of each part of the machining shape necessary for evaluating the parameter on the basis of the acquired parameter and the machining shape necessary for evaluation, a program creation unit that creates an evaluation program on the basis of the machining shape selected by the shape selection unit and the dimension of each part calculated by the dimension calculation unit, and a program output unit that outputs the evaluation program created by the program creation unit.

### TECHNICAL FIELD

The present invention relates to an evaluation program creation apparatus and a computer-readable recording medium on which a program is recorded.

### BACKGROUND ART

Conventionally, a machining program is created, and an industrial machine such as a machine tool or an electrical discharge machine is controlled based on the machining program to machine a workpiece. For example, in the machine tool, movement of each shaft is commanded within the machining program. A movement speed commanded at this time is a maximum speed of relative movement (tool movement) between the tool and the workpiece. When the machine tool is actually controlled based on this command, a movement speed of each shaft varies according to parameters such as maximum acceleration set for each shaft, a corner speed difference, acceleration/deceleration time constant after interpolation, and an inner rotation tolerance at the time of start of movement of each shaft or during machining of a corner and a curved part, and thus machining at a commanded movement speed is not performed in some cases. These parameters related to machining are adjusted by a machine tool operator while checking machined face quality of the workpiece after machining.

Patent Document 1 is a conventional art related to adjustment of parameters related to machining. Patent Document 1 discloses technology for extracting optimal control parameters by executing a test program after changing control parameters and evaluating execution results thereof based on a predetermined evaluation criterion. Further, Patent Document 2 discloses technology for adjusting parameters related to machining using machine learning technology.

### CITATION LIST

### Patent Document

Patent Document 1: JP 2016-130908 A
Patent Document 2: JP 2018-181217 A

### SUMMARY OF THE INVENTION

### Problem to be Solved by the Invention

When parameters of an industrial machine are adjusted, the parameters are adjusted and machining is attempted using the industrial machine in which the adjusted parameters are set. Thereafter, a machining result is evaluated to verify whether a target machining result is obtained. Then, when the result is not as expected, the above procedure is repeated. This procedure is the same regardless of whether the parameters are manually adjusted or whether the parameters are adjusted using simulation or machine learning. In this instance, an evaluation program is used to trial machining using the adjusted parameters.

The evaluation program is generally fixed, and the same evaluation program is used regardless of the adjusted parameters. Therefore, a conventional evaluation program needs to allow evaluation to be performed on various set values of parameters. FIG. 9 illustrates an example of a path of a tool controlled by an evaluation program. As illustrated in FIG. 9, the tool path controlled by the conventional evaluation program has a long side and includes at least square corners and rounded corners. For this reason, for example, even when a parameter related to a circular arc is not adjusted, a rounded corner is machined during evaluation. Evaluation related to machining of this rounded corner is not used for evaluation of an adjustment result of the parameter, and thus wasteful machining is obtained. Such wasteful machining during evaluation is a cause of lengthening a cycle time of parameter adjustment work.

Therefore, there is needed technology for providing an optimal evaluation program according to a parameter set value in a process of adjusting a parameter.

### Means for Solving Problem

An evaluation program creation apparatus according to the present disclosure solves the above problem by creating an optimal evaluation program sufficient to evaluate an item or a set value of the adjusted parameter according to the item or the set value when the parameter is adjusted.

Further, an aspect of the disclosure is an evaluation program creation apparatus for creating an evaluation program for evaluating adjustment of a parameter of an industrial machine, the evaluation program creation apparatus including a parameter acquisition unit configured to acquire a parameter related to machining by the industrial machine, a shape selector configured to select a machined shape necessary for evaluation of the parameter based on the parameter, a dimension calculator configured to calculate a dimension of each part of the machined shape necessary for evaluation of the parameter based on the parameter and the machined shape, a program creator configured to create an evaluation program based on a machined shape selected by the shape selector and a dimension of each part calculated by the dimension calculator, and a program output unit configured to output an evaluation program created by the program creator.

Another aspect of the disclosure is a computer-readable recording medium recording a program configured to cause a computer to operate as an evaluation program creation apparatus for creating an evaluation program for evaluating adjustment of a parameter of an industrial machine, the computer-readable recording medium recording a program configured to cause the computer to operate as a parameter acquisition unit configured to acquire a parameter related to machining by the industrial machine, a shape selector configured to select a machined shape necessary for evaluation of the parameter based on the parameter, a dimension calculator configured to calculate a dimension of each part of the machined shape necessary for evaluation of the parameter based on the parameter and the machined shape, a program creator configured to create an evaluation program based on a machined shape selected by the shape selector and a dimension of each part calculated by the dimension calculator, and a program output unit configured to output an evaluation program created by the program creator.

### Effect of the Invention

According to an aspect of the disclosure, each time adjustment of a parameter is attempted, it is possible to change to an evaluation program suitable for evaluating the adjusted parameter, and thus parameter adjustment efficiency is improved.

### BRIEF DESCRIPTION OF DRAWINGS

FIG. 1 is a schematic hardware configuration diagram of an evaluation program creation apparatus according to an embodiment of the invention;

FIG. 2 is a block diagram illustrating a schematic function of an evaluation program creation apparatus according to an embodiment of the invention;

FIG. 3 is a diagram illustrating an example of evaluation shape data;

FIG. 4 is a diagram for describing an example of a dimension condition of a square corner shape;

FIG. 5 is a diagram for describing an example of a dimension condition of a rounded corner shape;

FIG. 6 is a diagram for describing a process of joining machined shapes;

FIG. 7 is a diagram for describing a process of omitting a machined shape;

FIG. 8 is a diagram illustrating an example of the evaluation program creation apparatus that operates in cooperation with an acceleration/deceleration adjustment apparatus; and

FIG. 9 is a diagram illustrating a path of a tool controlled by an evaluation program.

### MODE(S) FOR CARRYING OUT THE INVENTION

Embodiments of the invention will be described below with reference to the drawings.

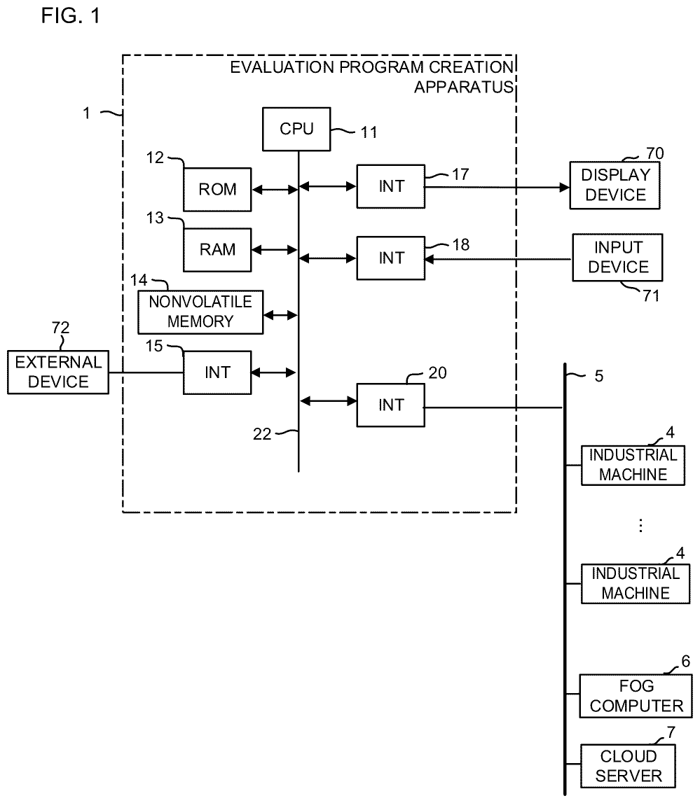

FIG. 1 is a schematic hardware configuration diagram illustrating a main part of an evaluation program creation apparatus according to an embodiment of the invention. The evaluation program creation apparatus 1 of the invention can be mounted, for example, as a controller that controls an industrial machine based on a control program. Furthermore, the evaluation program creation apparatus 1 of the invention may be mounted on a personal computer installed side by side with the controller that controls the industrial machine based on a control program, a personal computer, a cell computer, a fog computer 6, and a cloud server 7 connected to the controller via a wired/wireless network. In the present embodiment, an example is illustrated in which the evaluation program creation apparatus 1 is mounted on the personal computer connected via the wired/wireless network to the controller that controls the industrial machine based on the control program.

A CPU 11 included in the evaluation program creation apparatus 1 according to the present embodiment is a processor that controls the entire evaluation program creation apparatus 1. The CPU 11 reads a system program stored in a ROM 12 via a bus 22 and controls the entire evaluation program creation apparatus 1 in accordance with the system program. A RAM 13 temporarily stores temporary calculation data, display data, various data input from the outside, etc.

For example, a nonvolatile memory 14 includes a memory backed up by a battery (not illustrated), a solid state drive (SSD), etc., and a storage state thereof is maintained even when the power of the evaluation program creation apparatus 1 is turned off. The nonvolatile memory 14 stores data acquired from an industrial machine 2, control programs and data read from an external device 72 via an interface 15, data input via an input device 71, programs, data, and parameters acquired from an industrial machine 4 or another device via a network 5, etc. The programs, data, parameters, etc. stored in the nonvolatile memory 14 may be loaded in the RAM 13 at the time of execution/use. Further, various system programs such as known analysis programs are written to the ROM 12 in advance.

The interface 15 is an interface for connecting the CPU 11 of the evaluation program creation apparatus 1 to the external device 72 such as a USB device. From the external device 72, for example, a control program, setting data, etc. used for controlling the industrial machine 2 are read. Further, the control program, setting data, etc. edited in the evaluation program creation apparatus 1 can be stored in external storage means via the external device 72.

An interface 20 is an interface for connecting the CPU of the evaluation program creation apparatus 1 to the wired or wireless network 5. Another industrial machine 4 such as a machine tool or an electrical discharge machine, the fog computer 6, the cloud server 7, etc. are connected to the network 5 to mutually exchange data with the evaluation program creation apparatus 1.

Various data read on a memory, data obtained as a result of executing a program, etc. are output via an interface 17 and displayed on a display device 70. In addition, the input device 71 including a keyboard, a pointing device, etc. passes a command, data, etc. based on an operation by an operator to the CPU 11 via an interface 18.

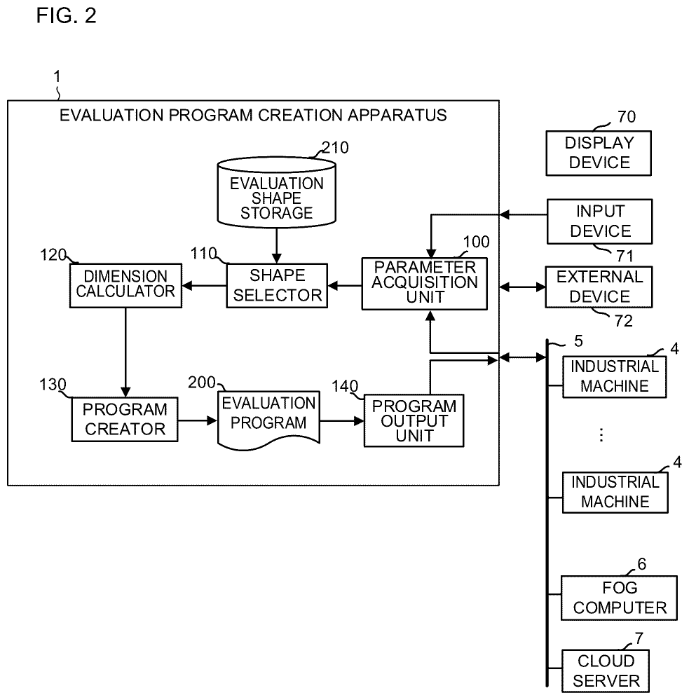

FIG. 2 illustrates a function of an evaluation program creation apparatus 1 according to a first embodiment of the invention as a schematic block diagram. Each function of the evaluation program creation apparatus 1 according to the present embodiment is realized by the CPU 11 included in the evaluation program creation apparatus 1 illustrated in FIG. 1 executing a system program and controlling an operation of each unit of the evaluation program creation apparatus 1.

The evaluation program creation apparatus 1 of the present embodiment includes a parameter acquisition unit 100, a shape selector 110, a dimension calculator 120, a program creator 130, and a program output unit 140. Further, an evaluation shape storage 210 that stores each parameter and evaluation shape data indicating a correspondence with a machined shape used for evaluating the parameter in advance is on the RAM 13 or the nonvolatile memory 14 of the evaluation program creation apparatus 1.

The parameter acquisition unit 100 acquires an item of a parameter subjected to evaluation related to machining by the industrial machine 4 and a parameter value thereof. An item of a parameter related to machining adjusted in the industrial machine 4 and a parameter value are acquired by the parameter acquisition unit 100. Examples of the parameter related to machining include acceleration of a straight line, jerk of a straight line, acceleration/deceleration time constant after interpolation, a corner speed difference, allowable acceleration of a curved surface, position loop gain, a feedforward coefficient, etc. For example, the parameter acquisition unit 100 may acquire an item and a parameter value for a parameter, a value of which has changed since previous reference, among parameters related to machining set in the industrial machine 4. In addition, a parameter related to edited machining in a machining program executed by the industrial machine 4 may be acquired. Further, for example, the operator may give a command from the input device 71 as to which parameter has been changed. Further, upon request from the dimension calculator 120, a value of an additional parameter required for dimension calculation may be obtained. The item of the parameter related to machining and the parameter value thereof acquired by the parameter acquisition unit 100 are output to the shape selector 110.

The shape selector 110 selects a machined shape necessary to evaluate the parameter value based on the item of the parameter and the parameter value subjected to evaluation. The shape selector 110 according to the present embodiment refers to the evaluation shape storage 210 that stores evaluation shape data indicating a correspondence between a parameter and a machined shape used to evaluate the parameter, and selects a shape to be used to evaluate each parameter.

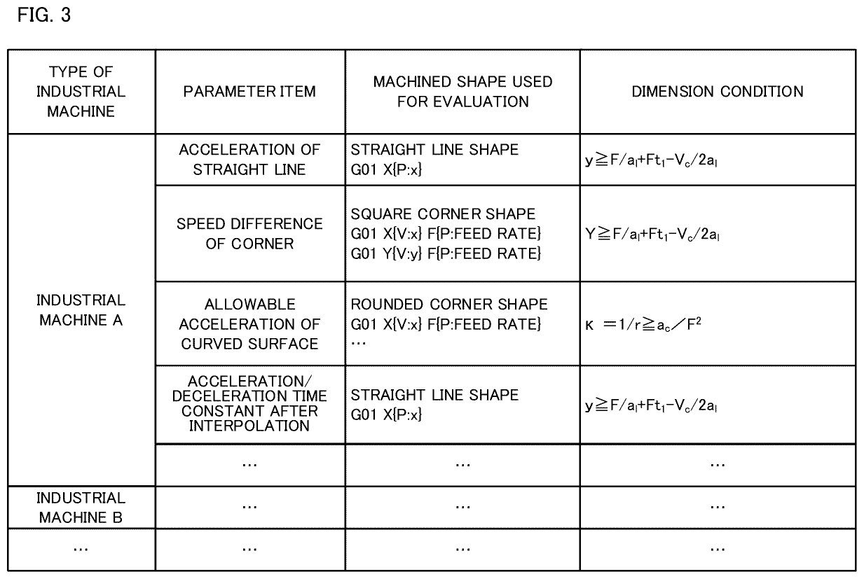

FIG. 3 illustrates an example of evaluation shape data stored in the evaluation shape storage 210 in advance. The evaluation shape data defines a correspondence between a parameter related to machining and a machined shape used to evaluate the parameter at least for each type of industrial machine. In the example of FIG. 3, the machined shape included in the evaluation shape data is indicated by a name of each shape. However, for example, each machined shape is preferably defined by a sequence of program commands used during machining into the shape. In this instance, for example, the square corner shape can be defined as a sequence of a program command including a value of a predetermined parameter and a variable that can be calculated under a dimension condition described below such as “G01 X{variable: x} F{parameter: feed rate}; G01 Y{variable: y} F{parameter: feed rate}”. Examples of the machined shape used for evaluation include a straight-line shape having a predetermined length, a corner shape having a predetermined angle, a rounded corner shape having a predetermined curvature and internal angle, minute line segments continuing a predetermined number of times, etc.

In each piece of evaluation shape data, a plurality of machined shapes may be associated with one parameter. This means that a plurality of machined shapes is needed to evaluate the parameter. In addition, each machined shape used for evaluation may be set for a range of an evaluated parameter. For example, setting may also be performed so that evaluation is performed using a right-angled corner shape when a corner speed difference is less than or equal to a predetermined value V₁, whereas evaluation is performed using two machined shapes of a right-angled corner shape and a corner shape bent at an acuter angle when the corner speed difference is greater than the predetermined value V₁.

The evaluation shape data may further include a condition related to a dimension of each part in each machined shape. A condition of a dimension may be defined in a form of a mathematical formula for calculating a dimension of a predetermined part of a machined shape from a value of a parameter related to machining. This mathematical formula may be used to calculate a value of a predetermined variable included in a sequence of program commands of a machined shape. In addition, a plurality of dimension conditions may be defined for one machined shape. A condition of a dimension of a machined shape is used in the dimension calculator 120.

Based on a parameter subjected to evaluation and a machined shape selected by the shape selector 110, the dimension calculator 120 calculates a dimension of each part of the machined shape necessary to evaluate each parameter. The dimension calculator 120 calculates a dimension of each part of each machined shape based on a dimension condition stored in the evaluation shape storage 210. The dimension calculator 120 acquires a value of an additional parameter required to calculate a dimension of each part from the parameter acquisition unit 100.

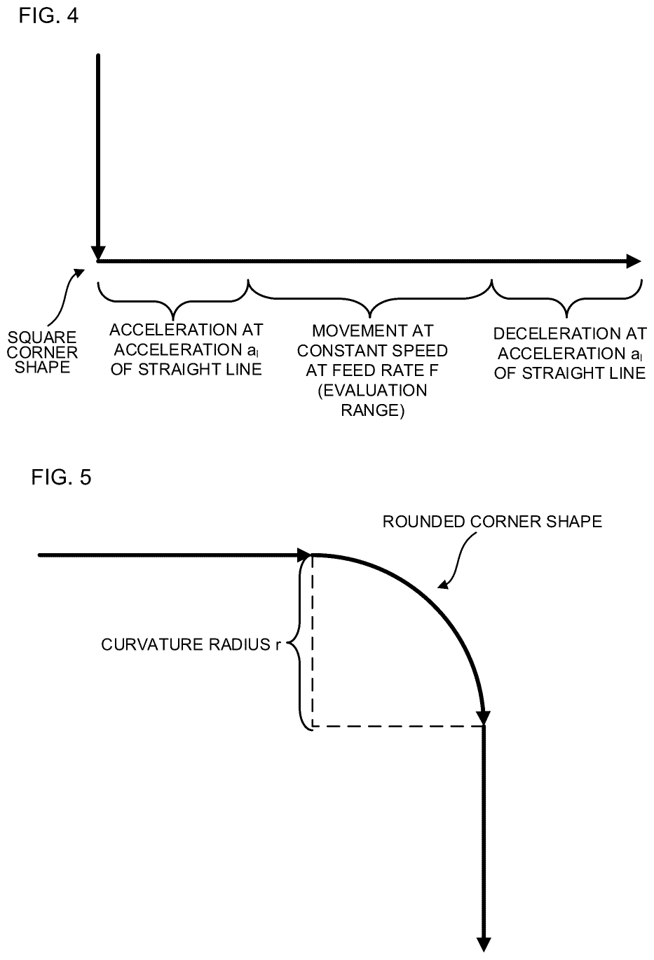

For example, the dimension calculator 120 determines a length dimension of a straight line after corner machining in a machined shape of a square corner based on a parameter value set as a parameter of a corner speed difference. FIG. 4 is a diagram illustrating speed change when machining a straight line after machining a square corner. As illustrated in FIG. 4, during machining into a straight-line shape, the tool accelerates to a feed rate F at acceleration a₁ of a straight line at the start of machining, moves at a constant speed at the feed rate F, and then decelerates to a feed rate 0 at the acceleration a₁ of the straight line. Then, in a part that moves at a constant speed at the feed rate F, acceleration and deceleration after passing a corner appear as vibrations. For this reason, a length dimension needs to be set so that this part has a predetermined length or more. Assuming that acceleration of the straight line is a₁, a corner speed difference is V_{c}, a feed rate is F, and a part that moves at a constant speed is required for ti seconds, a length dimension y of a straight line after corner machining may be calculated using the following Expression 1. Then, the dimension calculator 120 calculates the length dimension so that a machining time is shortest, that is, the length is shortest, within a range that satisfies this condition.

$$y \geq \frac{F}{{a}_{l}} + {Ft}_{1} - \frac{{V}_{c}}{2 {a}_{l}} \qquad [ Expression 1 ]$$

Further, for example, the dimension calculator 120 determines a curvature dimension of a machined shape of a rounded corner based on a value set as a parameter of allowable acceleration of a curved surface. FIG. 5 is a diagram illustrating a movement path of a tool when machining a rounded corner. A length of the curved surface when machining the rounded corner is determined by a curvature (radius of curvature). In general, when a machining state of the curved surface is evaluated, if the feed rate is F and the allowable acceleration of the curved surface is ac, it is desirable that a curvature K calculated by Expression 2 below satisfies a condition below. Note that r is the radius of curvature of the rounded corner. Then, the dimension calculator 120 calculates the curvature dimension so that the curvature is the smallest within a range that satisfies this condition.

$$κ = \frac{1}{r} \geq \frac{{a}_{c}}{{F}^{2}} \qquad [ Expression 2 ]$$

The program creator 130 creates an evaluation program 200 based on a machined shape selected by the shape selector 110 and a dimension of each part calculated by the dimension calculator 120. The evaluation program 200 created by the program creator 130 is obtained by successively combining machined shapes selected based on a parameter subjected to evaluation. Further, a dimension of each part of a tool path moved by the evaluation program 200 is a dimension calculated by the dimension calculator 120. The program creator 130 outputs the created evaluation program 200 to the program output unit 140.

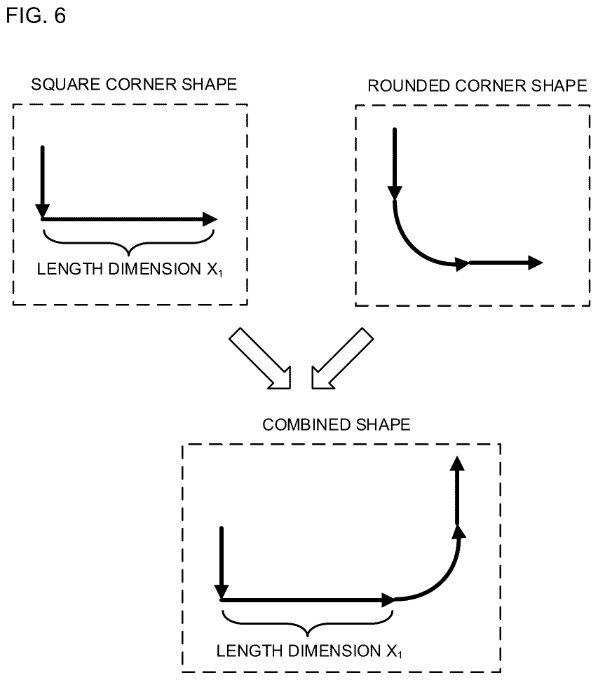

When machined shapes are combined back and forth, the program creator 130 changes an orientation of a subsequent machined shape so that a tool movement direction at an end point of a previous machined shape and a tool movement direction at a start point of the subsequent machined shape are smoothly connected to each other. In addition, when machined shapes are combined back and forth, the program creator 130 compares a last movement command of a previous machined shape with a first movement command of a subsequent machined shape. Then, when these are the same type of movement commands, the previous and subsequent movement commands are replaced with one movement command, and then the machined shapes are combined back and forth. In this instance, a dimension of the replaced movement command may be set so that a machining time is shortened within a range that satisfies a dimension condition defined for the previous and subsequent movement commands. For example, as illustrated in FIG. 6, the case where a rounded corner shape is combined after a square corner shape is considered. In this instance, a dimension condition is defined in a last movement command of the square corner shape. Furthermore, no dimension condition is defined in a first movement command of the rounded corner shape. In this case, the last movement command of the square corner shape and the first movement command of the rounded corner shape are combined after being replaced with movement commands that shorten a machining time within a range that satisfies the dimension condition of the last movement command of the square corner shape.

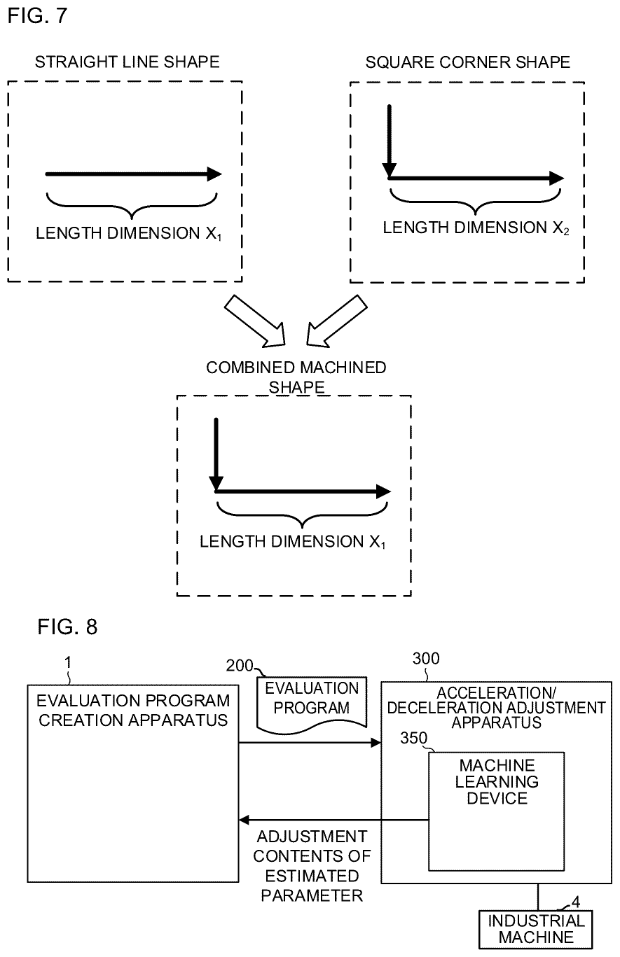

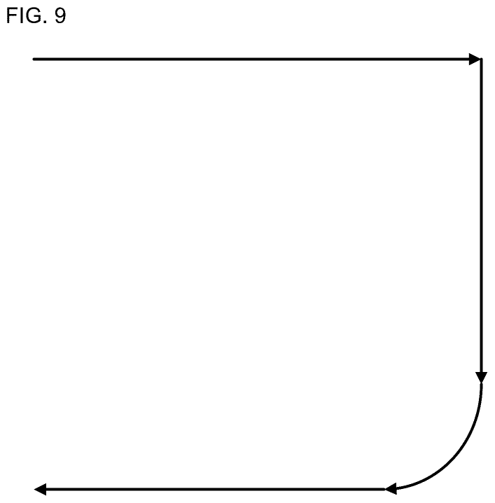

When there are machined shapes that can be commonly used to evaluate two or more parameters, the program creator 130 may integrate the machined shapes into one machined shape. For example, when it is necessary to evaluate a parameter of acceleration of a straight line and a parameter of a speed difference of a corner, the machined shapes each used for evaluation become a straight line shape and a square corner shape. Here, it is assumed that the dimension calculator 120 calculates a length dimension of the straight line shape to X₁, and a length dimension of the straight line after cornering machining of the square corner shape to X₂. In this instance, when the length of X₁ is greater than the length of X₂, as illustrated in FIG. 7, the shapes may be integrated into a square corner shape in which a length dimension of a straight line after corner machining is X₁. In the integrated shape, it is possible to evaluate both parameters of a parameter of acceleration of the straight line and a parameter of a corner speed difference in the straight line after corner machining.

The program output unit 140 outputs the evaluation program 200 created by the program creator 130. The program output unit 140 may present the evaluation program 200 to the operator by displaying/outputting the evaluation program 200 on/to the display device 70. Further, the program output unit 140 may output the evaluation program 200 to the industrial machine 4 via the network 5. Furthermore, the evaluation program 200 may be output to a higher-level computer such as the fog computer 6 or the cloud server 7.

In the evaluation program creation apparatus 1 having the above configuration, it is possible to change to an evaluation program suitable for evaluating an adjusted parameter each time adjustment of a parameter is attempted, and thus parameter adjustment efficiency is improved. For example, when the operator is performing adjustment work for parameters of a given industrial machine, each time a parameter is adjusted, an evaluation program is created to perform machining into a minimum necessary shape to evaluate the parameter. In this way, there is no need to perform unnecessary machining when compared to the case where a fixed evaluation program is executed each time a parameter is adjusted. Therefore, a cycle time for parameter adjustment is improved. This is not limited to cases in which parameters are manually adjusted, but can also be used, for example, in cases in which parameters are adjusted using a simulation device, a machine learning device, etc.

For example, as illustrated in FIG. 8, the case is considered where there is an acceleration/deceleration adjustment apparatus 300 that adjusts a parameter related to machining in the industrial machine 4 using machine learning technology. The acceleration/deceleration adjustment apparatus 300 includes a machine learning device 350 that estimates adjustment of a parameter suitable for a condition. Then, after adjusting a parameter estimated by the machine learning device 350, the acceleration/deceleration adjustment apparatus 300 attempts machining, and evaluates adjustment of the parameter estimated by the machine learning device 350 from a result thereof. The machine learning device 350 learns adjustment of the parameter based on an evaluation result. In the acceleration/deceleration adjustment apparatus 300 that performs such an operation, when the machine learning device 350 estimates adjustment of the parameter, the estimated parameter adjustment is output to the evaluation program creation apparatus 1 of the invention. Then, using the evaluation program 200 output by the evaluation program creation apparatus 1, machining is attempted and parameter adjustment is evaluated. In this way, it is expected to significantly improve evaluation efficiency of parameter adjustment repeatedly performed.

Even though the embodiments of the invention have been described above, the invention is not limited to the above-described embodiments, and can be implemented in various aspects by making appropriate changes.

EXPLANATIONS OF LETTERS OR NUMERALS

| | |
|---|---|
| 1 | EVALUATION PROGRAM CREATION APPARATUS |
| 2 | INDUSTRIAL MACHINE |
| 4 | INDUSTRIAL MACHINE |
| 5 | NETWORK |
| 6 | FOG COMPUTER |
| 7 | CLOUD SERVER |
| 11 | CPU |
| 12 | ROM |
| 13 | RAM |
| 14 | NONVOLATILE MEMORY |
| 15, 17, | INTERFACE |
| 18, 20 | |
| 22 | BUS |
| 70 | DISPLAY DEVICE |
| 71 | INPUT DEVICE |
| 72 | EXTERNAL DEVICE |
| 100 | PARAMETER ACQUISITION UNIT |
| 110 | SHAPE SELECTOR |
| 120 | DIMENSION CALCULATOR |
| 130 | PROGRAM CREATOR |
| 140 | PROGRAM OUTPUT UNIT |
| 200 | EVALUATION PROGRAM |
| 210 | EVALUATION SHAPE STORAGE |

1. An evaluation program creation apparatus for creating an evaluation program for evaluating adjustment of a parameter of an industrial machine, the evaluation program creation apparatus comprising:
a parameter acquisition unit configured to acquire a parameter related to machining by the industrial machine;
a shape selector configured to select a machined shape necessary for evaluation of the parameter based on the parameter;
a dimension calculator configured to calculate a dimension of each part of the machined shape necessary for evaluation of the parameter based on the parameter and the machined shape;
a program creator configured to create an evaluation program based on a machined shape selected by the shape selector and a dimension of each part calculated by the dimension calculator; and
a program output unit configured to output an evaluation program created by the program creator.

2. The evaluation program creation apparatus according to claim 1, wherein the dimension of each part includes at least either a distance of a straight line or a curvature of a curved surface.

3. A computer-readable recording medium recording a program configured to cause a computer to operate as an evaluation program creation apparatus for creating an evaluation program for evaluating adjustment of a parameter of an industrial machine, the computer-readable recording medium recording a program configured to cause the computer to operate as:
a parameter acquisition unit configured to acquire a parameter related to machining by the industrial machine;
a shape selector configured to select a machined shape necessary for evaluation of the parameter based on the parameter;
a dimension calculator configured to calculate a dimension of each part of the machined shape necessary for evaluation of the parameter based on the parameter and the machined shape;
a program creator configured to create an evaluation program based on a machined shape selected by the shape selector and a dimension of each part calculated by the dimension calculator; and
a program output unit configured to output an evaluation program created by the program creator.
